(19) United States
(12) Patent Application Publication
(10) Pub. No.: US 2011/0089743 A1
(43) Pub. Date: Apr. 21, 2011

(54) Motor Vehicle Seat Adjustment Mechanism, and Vehicle Seat

(75) Inventors: Yann Reubeuze, Landigou (FR); Francois Baloche, La Carneille (FR)

(73) Assignee: Faurecia Sieges d'Automobile, Nanterre (FR)

(21) Appl. No.: 12/908,056

(22) Filed: Oct. 20, 2010

(30) Foreign Application Priority Data
Oct. 20, 2009 (FR) 09 57354

(51) Int. Cl. B60N 2/02

(52) U.S. Cl. 297/463.1

(57) ABSTRACT

A motor vehicle seat adjustment mechanism, comprising: a first end-plate, a second end-plate pivoting about a pivot axis, a locking member which is movable from an inactive position to an active position, with the locking member comprising a first and a second guide surfaces, a guide member associated with the locking member, comprising a third and a fourth guide surfaces, with the third and fourth guide surfaces having a conical configuration which widens more than the first and second guide surfaces.

### FIELD OF THE INVENTION

The invention relates to vehicle seat adjustment mechanisms, and to vehicle seats equipped with such mechanisms.

### BACKGROUND OF THE INVENTION

More specifically, the invention relates to a motor vehicle seat adjustment mechanism comprising:
a first end-plate,
a second end-plate comprising a circumferential locking surface, with said second end-plate mounted to pivot relative to the first end-plate about a pivot axis,
a control member, mounted on the first end-plate,
at least one locking member comprising a locking surface complementary to the locking surface of the second end-plate, said locking member being movable relative to the second end-plate upon actuation of the control member, from
   an inactive position, in which the first and second locking surfaces do not cooperate, allowing a relative rotation of the first and second end-plates about said pivot axis, to
   an active position, in which the first and second locking surfaces cooperate, preventing said relative rotation,

said locking member comprising a first guide surface,
at least one guide member associated with the locking member, secured to the first end-plate.

Such adjustment mechanisms with a pivoting locking member are known, for example from FR 2 722 150.

There is a desire for further improvements to such adjustment mechanisms, however, particularly to reduce the play in these mechanisms. The play increases with age and may ultimately have serious implications for occupant safety.

### SUMMARY OF THE INVENTION

For this reason, in a mechanism of the invention: the locking member also comprises a second guide surface, the guide member comprises a third and a fourth guide surfaces respectively adapted to cooperate with the first and second guide surfaces in order to guide the locking member during its displacement between its active and inactive positions, and the first and second guide surfaces have a conical configuration, widening from a narrow portion to a wide portion;

the third and fourth guide surfaces have a conical configuration widening from a narrow portion which is narrower than the narrow portion of the first and second guide surfaces, to a wide portion which is wider than the wide portion of the first and second guide surfaces.

These arrangements provide a conical guide for the locking member, which maintains a reduced play for the entire life of the product.

In some embodiments of the invention, one and/or another of the following arrangements may additionally be used:
in the active position, when viewed in a cross-section transverse to the pivot axis, there exists a single point on each of the first and second guide surfaces which cooperates with a point on each of the third and fourth guide surfaces;
the first and second guide surfaces each present an arc of a circle that has a radius and a center, said centers being offset,

the third and fourth guide surfaces each present an arc of a circle that has a radius and a center, said centers being offset,

the third and fourth guide surfaces each present a radius that is respectively greater than the radius of the first and second guide surfaces;
the first and second locking surfaces are toothed surfaces each comprising a plurality of teeth and, in the active position, a single tooth of the first locking surface cooperates with a single tooth of the second locking surface,
the locking member comprises a stop, the control member comprises a deactivation surface, said deactivation surface of the control member cooperating with the stop of the locking member to move the locking member from its active position to its inactive position,
the mechanism comprises a plurality of said locking members distributed circumferentially about the pivot axis,
the mechanism is single-stage,
the mechanism comprises an elastic member biasing the control member towards a position in which the locking member is maintained in the active position,
the mechanism additionally comprises a supplemental stress-handling system for stresses exerted circumferentially about the pivot axis.

In another aspect, the invention relates to a vehicle seat comprising a first element, a second element, and such an adjustment mechanism, wherein the first and second end-plates are respectively fixed to the first and second elements.

In one embodiment, the adjustment mechanism is a first adjustment mechanism, with the seat additionally comprising a second such adjustment mechanism, wherein the first and second end-plate of the second adjustment mechanism are respectively fixed to the first and second elements, and wherein the deactivation surface of the control member of the second adjustment mechanism comprises an overtravel adapted to take into account an angular offset of the first and second adjustment mechanisms about the pivot axis.

Other features and advantages of the invention will become apparent from the following description of two of its embodiments, provided as non-limiting examples with reference to the attached drawings.

### BRIEF DESCRIPTION OF THE DRAWINGS

In the drawings:

FIG. 1 is a schematic side view of a motor vehicle seat,

FIG. 2 is an exploded perspective view of an adjustment mechanism according to a first embodiment,

FIG. 3 is a cross-sectional view of the locked state of the adjustment mechanism along in FIG. 2,

FIG. 4 is a detail view of FIG. 3,

FIG. 5 is a view similar to FIG. 4, but the mechanism is in the unlocked state,

FIGS. 6, 7a and 7b are enlarged views of areas VI, VIIA and VIIB of FIG. 4, respectively,

FIGS. 8a and 8b are enlarged views of areas VIIIA and VIIIB of FIG. 5, respectively,

FIG. 9 is a view similar to FIG. 2 but for a second embodiment, and

FIG. 10 is a partial cross-sectional view of FIG. 9 along line X-X of FIG. 9.

In the different figures, the same references designate identical or similar elements.

### DETAILED DESCRIPTION

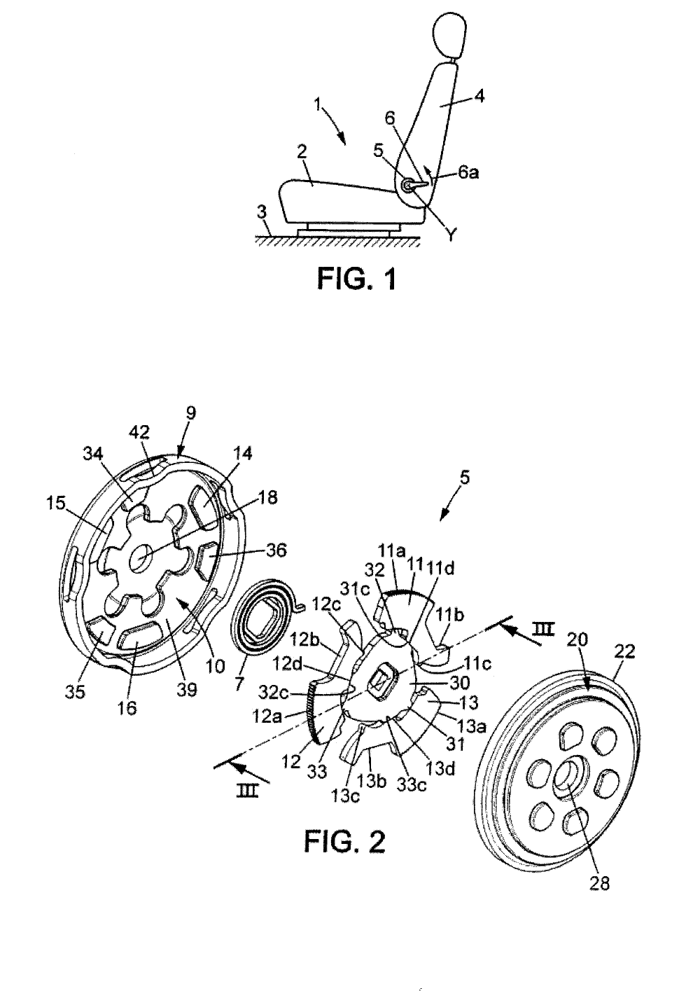

As is represented schematically in FIG. 1, the invention relates to a vehicle seat 1 which comprises a horizontal squab 2 mounted on a floor 3 of the vehicle, and a backrest 4 pivotably mounted on the horizontal squab 2 by means of at least one articulation mechanism 5, pivoting about a primary articulation axis Y which extends transversely and is substantially horizontal.

The articulation mechanism 5 is, for example, single-stage, and can be controlled, for example, by means of a handle 6 which can be turned in a direction 6a to release the backrest 4 and allow it to pivot about the main axis of rotation Y.

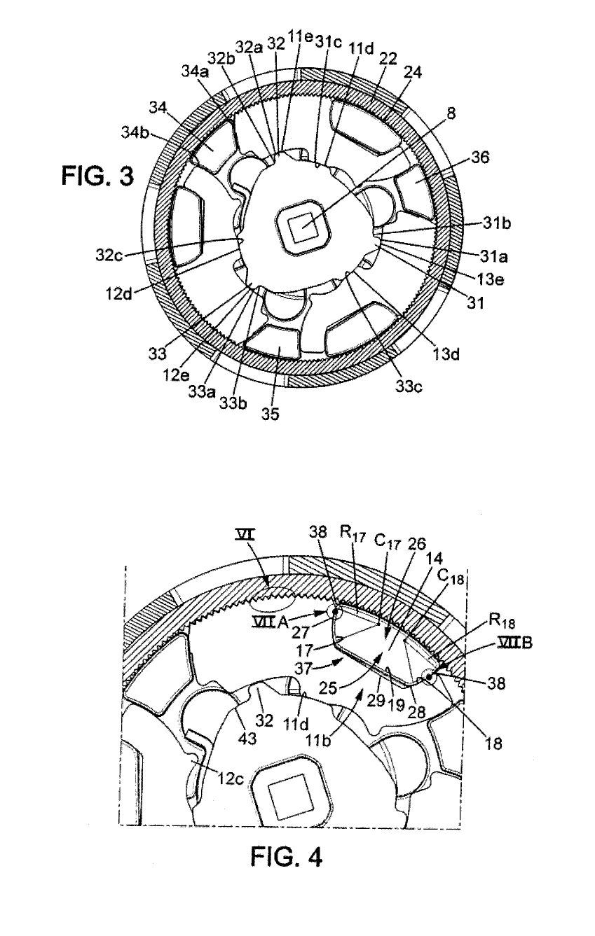

As is illustrated in FIGS. 2 to 5, the articulation mechanism 5 in a first embodiment comprises a first end-plate 10, a second end-plate 20, three locking elements 11, 12, 13, or locking members, a control member 30, or cam, and a control shaft 8 (visible in FIG. 3), traversing the central opening of the cam and of each of the end-plates.

The first end-plate 10 is in the general form of a rigid disk, formed by stamping, and is fixed for example to the horizontal squab 2. It comprises a bore along the main axis of rotation Y, forming a passage 18 for the control shaft 8, and connected to the handle 6.

It additionally comprises three identical guide members 14, 15, 16 which are conical and are peripherally distributed around the main axis of rotation, for example 120° apart.

A description of the guide member 14 is now given with reference to FIG. 4, with the understanding that the guide members 15 and 16 have similar geometries. The guide member 14 comprises two guide surfaces 17 and 18 which are connected to each other by a connecting surface 19. These three surfaces are cylindrical in form, with a generatrix parallel to the axis of rotation Y. The cross-section of the guide surfaces 17 and 18 transverse to the Y axis has a profile that is an arc of a circle with respective radii R₁₇, R₁₈ (equal, for example) and centers C₁₇, C₁₈. The centers C₁₇ and C₁₈ are not the same and are sufficiently far apart to provide a connecting surface 19 which has, for example, a profile that is an arc of a circle with a radius greater than R₁₇ and R₁₈, or is flat, or has some other profile.

Thus, on a radially inner side (close to the Y axis), the guide member 14 comprises a narrow portion 25 which widens into a wide portion 26, situated on a radially outer side as one moves away from the Y axis.

Returning to FIGS. 2 and 3, the first end-plate 10 additionally comprises three supplemental retaining members 34, 35, 36 arranged circumferentially, each positioned between two locking members 11, 12, 13. As these three members are identical in this example, only the member 34 will be described: it comprises a first surface 34a facing a complementary surface of the locking member 11 and a second surface 34b facing a complementary surface of the locking member 12 (these are all cylindrical with the generatrix parallel to the Y axis). However, these surfaces are not intended to interact with the locking members during normal operation of the mechanism.

The general shape of the second end-plate 20 is a rigid disk, formed by stamping, which is fixed to the backrest 4 in this case. It comprises a peripheral ring 22 equipped with a set of teeth 24, and a cylindrical bore having a circular cross-section which follows the main axis of rotation Y and forms a passage 28 for the control shaft.

The first end-plate 10 also comprises a peripheral ring 9 with retaining elements 42 projecting radially towards the center, for retaining the second end-plate 20 inside the first end-plate 10, preventing relative translational movement of these two end-plates along the Y axis while allowing their relative rotation about this axis.

Alternatively, such retention can be achieved by a metal ring crimped onto the perimeter of the first end-plate 10 and fixed to the second end-plate 20, allowing relative pivoting between these two end-plates about the main axis of rotation Y, or any other appropriate manner.

The control member 30, or cam, has three hooks 31, 32, 33 and three activation surfaces 31c, 32c, 33c intended to cooperate with each of the respective locking elements 11, 12, 13. Each hook 31, 32, 33, provided for deactivating the locking members, comprises a retention surface 31a, 32a, 33a extending radially slantwise and delimits a notch 31b, 32b, 33b open towards the periphery of the cam 30.

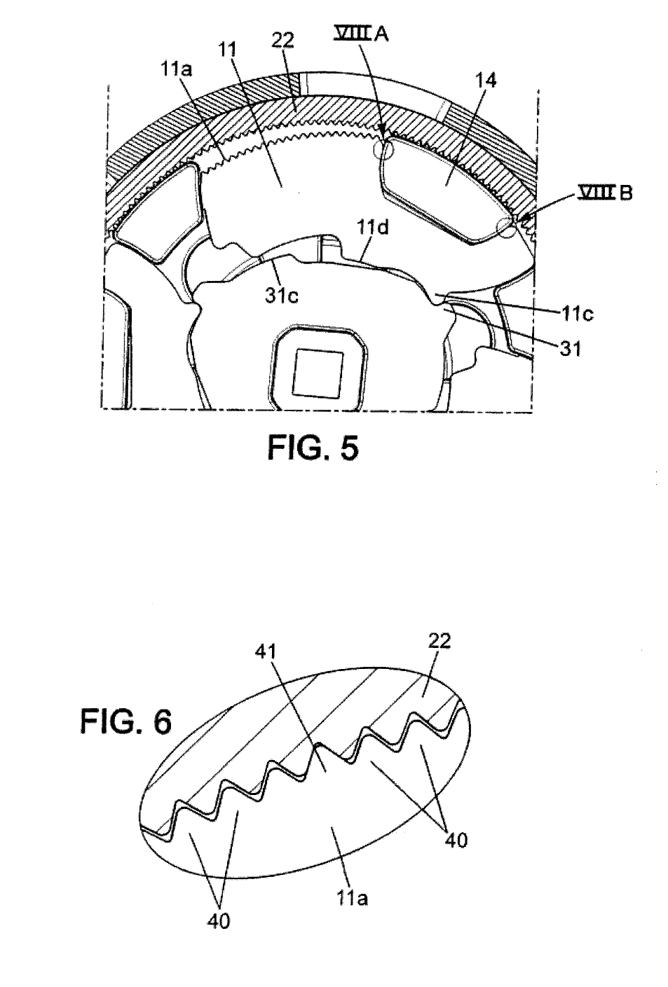

The cam 30 is secured to the shaft 8 and is able to rotate about the main axis of rotation Y, between a locked position illustrated in FIG. 3 and an unlocked position illustrated in FIG. 5.

The cam 30 cooperates with the locking elements 11, 12, 13 in a plane extending perpendicularly to the main axis of rotation Y, such that the cam 30 does not extend in the direction of the main axis of rotation Y between the locking elements 11, 12, 13 and the first end-plate 10, nor between the locking elements 11, 12, 13 and the second end-plate 20, but cooperates radially to the main axis of rotation Y with the locking elements 11, 12, 13.

A spring 7 tends to return the cam 30 to the locked position.

The locking elements 11, 12, 13 are arranged regularly (120° apart) in the first end-plate 10. They each comprise a set of teeth 11a, 12a, 13a, a guide portion 11b, 12b, 13b, a stop 11c, 12c, 13c, and an activation portion 11d, 12d, 13d.

Next the locking member 11 will be described, with the understanding that such a description can also apply to the locking members 12 and 13.

As can be seen in FIG. 6, the set of teeth 11a is complementary to the teeth of the ring 22. For example, it comprises a plurality of teeth 40, 41. For example, the set of teeth 11a has teeth in two different formats: small teeth 40 and large teeth 41. In the example presented, there is only one large tooth 41, and the other teeth 40 are smaller in format. For example, the large tooth 41 is substantially located in the center of the set of teeth. In the specific example, there are 13 small teeth 40 on the left and 9 small teeth 40 on the right of the large tooth 41.

The format of the large tooth 41 is chosen so that it fits perfectly with the teeth 24 of the ring gear 22 of the second end-plate 20. These teeth 24 all have, for example, the same aperture angle.

However, as a variation, a set of teeth 11a comprising uniform teeth could be used.

A description of the guide portion 11b is now given with reference to FIG. 4. The guide portion 11b comprises two guide surfaces 27 and 28 connected to each other by a connecting surface 29. These three surfaces are cylindrical with the generatrix parallel to the axis of rotation Y. The guide surfaces have, when viewed in a cross-section transverse to the Y axis, a profile that is an arc of a circle with respective radii R₂₇, R₂₈ (equal, for example), and with offset centers.

Thus, from a radially inner side (close to the Y axis), the guide portion comprises a narrow portion 37 which widens to a wide portion 38 situated on a radially outer side as one moves further away from the Y axis.

The guide surfaces and connecting surface 27, 28, 29 are arranged to face the respective guide surfaces and connecting surface 17, 18 and 19 of the guide member 14. Thus the guide surfaces 17 and 18 of the guide member have a conical configuration which widens from the narrow portion 25, narrower than the narrow portion 37 of the guide surfaces of the guide portion of the locking member, to a wide portion, wider than the wide portion 38 of the guide surfaces of the guide portion of the locking member.

In the active position represented in FIG. 4, the cam presses against the activation surface 11d, 12d, 13d of each of the locking elements 11, 12, 13, by means of the bearing surfaces 31c, 32c, 33c, in order to maintain the locking elements in the active position.

When the locking elements are in the active position, the set of teeth 11a, 12a, 13a cooperates with the teeth 24 of the ring 22, as illustrated in FIG. 4, to prevent rotation between the first end-plate 10 and the second end-plate 20 about the main axis of rotation Y.

The large tooth 41 is the only tooth to penetrate all the way into the corresponding tooth of the ring 22, as represented in FIG. 6. The other teeth 40 of the locking member are engaged with the corresponding teeth of the set of teeth 22, but only partially, being without contact or only having one side in contact.

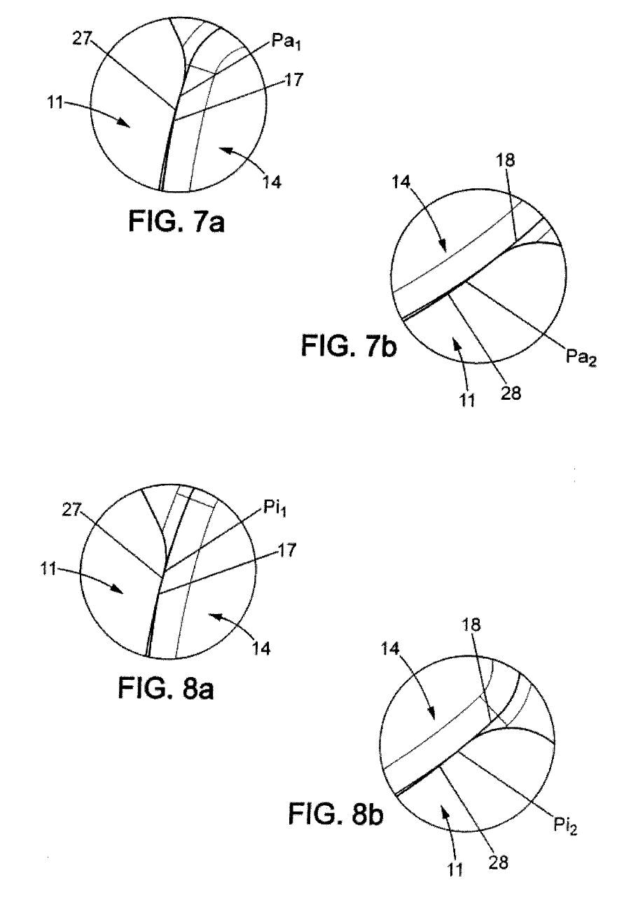

In the active position represented in FIG. 4, viewed in a cross-section transverse to the pivot axis, there exists a single point Pa1 (FIG. 7a), Pa2 (FIG. 7b) on each of the guide surfaces 27, 28 of the locking member which cooperates with a respective point on the guide surfaces 17, 18 of the guide member.

During the life of the product, the position of these points may change due to wear. However, because the shapes are complementary as described above, it is guaranteed that a single such point of contact will always exist in the active position.

In the normal locked position, four forces are therefore applied to the locking member:
the resultant of the stresses applied by the ring 22 of the second end-plate 20 on the set of teeth 11a (in particular on the single tooth 41),
the force applied by the first end-plate at point Pa1,
the force applied by the first end-plate at point Pa2,
the force applied by the cam on the activation portion 11d.

This isostatism guarantees that, when stresses are applied to the mechanism which attempt to rotate one of the two end-plates relative to the other about the Y axis when the locking members are in the locked position (for example the occupant's back pressing against the backrest, or someone pushing on the top of the backrest), no play is felt because there is no displacement in such case of the abovementioned points of contact (up to a certain predefined level corresponding to this type of stresses).

In case of a crash, where significant stresses may be relayed to the mechanism, the small teeth 40 will each in turn enter and cooperate with the complementary teeth of the ring 22, to retain the backrest on the horizontal squab in an effective manner. If applicable, the locking members will also press against the retaining members 34, 35, 36. The hook 31, 32, 33 will also contribute to retaining the locking member by pressing against a facing corresponding retention surface 11e, 12e, 13e of the locking member.

The cooperation between the guide portions 11b, 12b, 13b and the guide members 14, 15, 16 allows the locking elements 11, 12, 13 to move between an active position and an inactive position within a plane normal to the Y axis. The faces of the locking elements 11, 12, 13 which are normal to the Y direction press against and slide over the front parallel faces of the first and second end-plates (front face 39 of the first end-plate 10 visible in FIG. 2, radially outer ring of the second end-plate not visible). In the inactive position of the locking elements, as illustrated in FIG. 5, the sets of teeth 11a, 12a, 13a are at a distance from the teeth 24 of the ring 22, which allows unrestricted rotation between the first end-plate 10 and the second end-plate 20 about the main axis of rotation Y.

When the cam pivots from its locked position to its unlocked position when the control shaft is actuated (by a user wanting to unlock the mechanism in order to adjust the relative orientation of the two end-plates), the activation surfaces 31c, 32c, 33c disengage from the respective activation surfaces 11d, 12d, 13d of the locking members. Each of the retention surfaces 31a, 32a, 33a then cooperates with the stop 11c, 12c, 13c of the respective locking member 11, 12, 13 to bring said respective locking member into the inactive position as the stop 11c, 12c, 13c is inserted into the respective notch 31b, 32b, 33b.

Due to the configuration described above, in the inactive position represented in FIG. 5, when viewed in a cross-section transverse to the pivot axis, there exists a single point Pi1 (FIG. 8a), Pi2 (FIG. 8b) on each of the guide surfaces 27, 28 of the locking member which cooperates with a respective point on the guide surfaces 17, 18 of the guide member.

When the user releases the handle, freeing the control shaft 8, the spring 7 displaces the cam 30 towards its active position. The hooks 31, 32, 33 of the cam once again disengage from the stops 11c, 12c, 13c of the respective locking members, then the activation surface 31c, 32c, 33c of the cam forces the respective locking members from their inactive position towards their previously described active position. During this displacement, the locking members are conically guided by cooperation of the guide surfaces 17 and 27, and 18 and 28, until the previously described locked position is reached.

If the seat comprises two such adjustment mechanisms, for example such a mechanism on each side of the seat, and these mechanisms are not connected to each other, such that the occupant must activate the two mechanisms separately (although possibly using a common control member such as a release lever), there can be an overtravel 43 on the cam (FIG. 4), just before the hook 32, to take into account any angular offset between the two mechanisms.

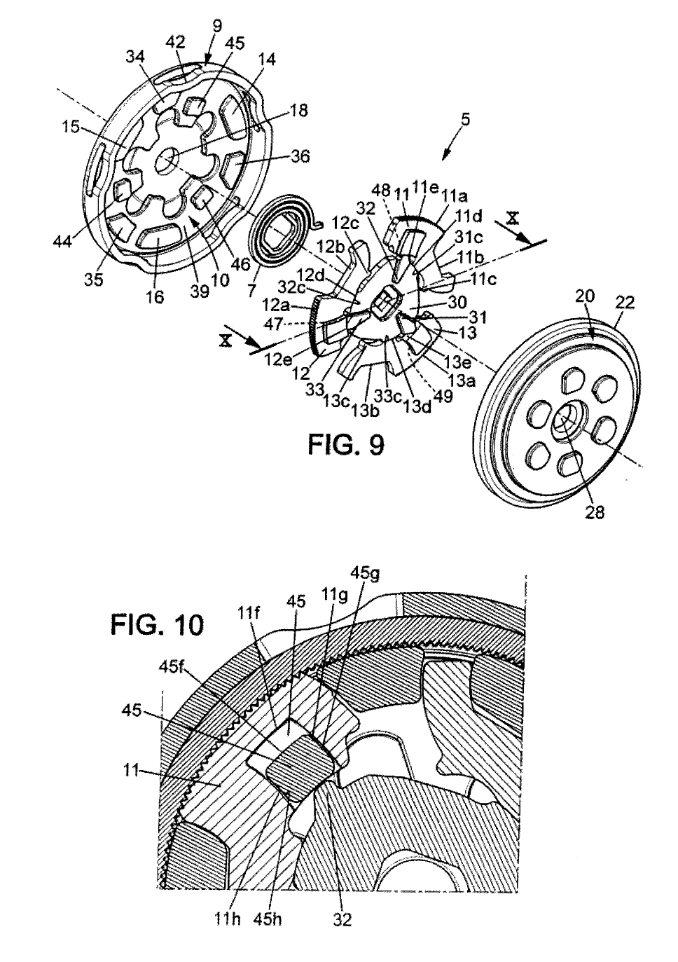

A second embodiment is represented in FIG. 9. Elements of this second embodiment which are the same as in the first embodiment are not described again. This second embodiment is primarily distinguished from the first embodiment by a supplemental stress-handling system for stress to further limit a possible rotational movement about the Y axis of the locking members 11, 12, 13 relative to the first end-plate 10 in case of abnormally high stresses.

For example, this stress-handling mechanism comprises a plurality of projections 44, 45, 46, protruding from the inner face 39 of the first end-plate 10 in the Y direction, each in the direction of a respective locking member. These projections are, for example, formed by stamping of the central portion of the end-plate 10.

On each of the corresponding locking members, there is a recess 47, 48, 49 formed in the face of the locking member, facing the inner face 39 of the first end-plate 10, and of sufficient dimensions to receive the corresponding projection 44, 45, 46 all along the path of the locking member 12 between its active and inactive positions. Thus the circumferential faces 45f of the projection 45 and 11f of the recess are relatively far apart when the locking member is locked (FIG. 10), and are closer in the unlocked position. These recesses 47, 48, 49 are, for example, formed by stamping the locking members, which results in a projection, visible in FIG. 9, being formed on the face opposite each locking member.

Details of the projection 45 are shown in FIG. 10, with the understanding that the configuration of projections 44 and 46 can be similar.

The radial faces 45g, 45h of the projection 45 and the respectively corresponding radial faces 11g, 11h of the recesses are sufficiently close to enable an interaction between a radial face of the projection and a corresponding radial face of the recess the moment an unwanted rotational movement begins about the Y axis of the locking members relative to the first end-plate 10, without coming into contact during normal operation of the mechanism.

Of course, if necessary, the front face of the second end-plate 20 can also be adapted to receive the locking members having this new geometry and to guide them in their movement during normal operation of the mechanism.

The retention surface 11e, 12e and 13e of each locking member can be placed on the inner circumferential face of the projection formed by stamping each locking member in order to form said recesses 47, 48 and 49. In this case, the hooks 31, 32 and 33 may also extend into a plane that is offset from the general plane of the cam 30, facing the respective retention surfaces, while also extending into the plane of the cam, of course, so as to interact with the respective stop 11c, 12c, 13c of the corresponding locking member.

Further, a change in the direction of rotation of the cam is possible.

1. A motor vehicle seat adjustment mechanism, wherein the mechanism comprises:
a first end-plate,
a second end-plate comprising a circumferential locking surface, with said second end-plate mounted to pivot relative to the first end-plate about a pivot axis,
a control member, mounted on the first end-plate,
at least one locking member comprising a locking surface complementary to the locking surface of the second end-plate, said locking member being movable relative to the second end-plate upon activation of the control member, from
an inactive position, in which the first and second locking surfaces do not cooperate, allowing a relative rotation of the first and second end-plates about said pivot axis, to
an active position, in which the first and second locking surfaces cooperate, preventing said relative rotation,
said locking member comprising a first guide surface,
at least one guide member associated with the locking member, secured to the first end-plate,
wherein the locking member also comprises a second guide surface,
wherein the guide member comprises a third and a fourth guide surfaces respectively adapted to cooperate with the first and second guide surfaces in order to guide the locking member during a displacement of the locking member between its active and inactive positions,
wherein the first and second guide surfaces have a conical configuration, widening from a narrow portion to a wide portion,
wherein the third and fourth guide surfaces have a conical configuration widening from a narrow portion which is narrower than the narrow portion of the first and second guide surfaces, to a wide portion which is wider than the wide portion of the first and second guide surfaces.

2. Mechanism according to claim 1 wherein, in the active position, when viewed in a cross section transverse to the pivot axis, there exists a single point on each of the first and second guide surfaces which cooperates with a point on each of the third and fourth guide surfaces.

3. A mechanism according to claim 1, wherein the first and second guide surfaces each present an arc of a circle that has a radius and a center, said centers being offset,
wherein the third and fourth guide surfaces each present an arc of a circle that has a radius and a center, said centers being offset,
wherein the third and fourth guide surfaces each present a radius that is respectively greater than the radius of the first and second guide surfaces.

4. A mechanism according to claim 1, wherein the first and second locking surfaces are toothed surfaces each comprising a plurality of teeth, and wherein, in the active position, a single tooth of the first locking surface cooperates with a single tooth of the second locking surface.

5. A mechanism according to claim 1, wherein the locking member comprises a stop, wherein the control member comprises a deactivation surface, said deactivation surface of the control member cooperating with the stop of the locking member to move the locking member from its active position to its inactive position.

6. A mechanism according to claim 1, comprising a plurality of said locking members distributed circumferentially about the pivot axis.

7. A mechanism according to claim 1 that is single-stage.

8. A mechanism according to claim 1, comprising an elastic member biasing the control member towards a position in which the locking member is maintained in the active position.

9. A mechanism according to claim 1, additionally comprising a supplemental stress-handling system for stresses exerted circumferentially about the pivot axis.

10. A motor vehicle seat comprising a first element, a second element, and an adjustment mechanism according to claim 1, wherein the first and second end-plates are respectively fixed to the first and second elements.

11. A motor vehicle seat according to claim 10, wherein the adjustment mechanism is a first adjustment mechanism, with the seat additionally comprising a second adjustment mechanism according to claim 4, a motor vehicle seat adjustment mechanism, wherein the mechanism comprises:
a first end-plate,
a second end-plate comprising a circumferential locking surface, with said second end-plate mounted to pivot relative to the first end-plate about a pivot axis,
a control member, mounted on the first end-plate,
at least one locking member comprising a locking surface complementary to the locking surface of the second end-plate, said locking member being movable relative to the second end-plate upon activation of the control member, from
an inactive position, in which the first and second locking surfaces do not cooperate, allowing a relative rotation of the first and second end-plates about said pivot axis, to
an active position, in which the first and second locking surfaces cooperate, preventing said relative rotation,
said locking member comprising a first guide surface,
at least one guide member associated with the locking member, secured to the first end-plate,
wherein the locking member also comprises a second guide surface,
wherein the guide member comprises a third and a fourth guide surfaces respectively adapted to cooperate with the first and second guide surfaces in order to guide the locking member during a displacement of the locking member between its active and inactive positions,
wherein the first and second guide surfaces have a conical configuration, widening from a narrow portion to a wide portion,
wherein the third and fourth guide surfaces have a conical configuration widening from a narrow portion which is narrower than the narrow portion of the first and second guide surfaces, to a wide portion which is wider than the wide portion of the first and second guide surfaces, a mechanism according to claim 1, wherein the first and second locking surfaces are toothed surfaces each comprising a plurality of teeth, and wherein, in the active position, a single tooth of the first locking surface cooperates with a single tooth of the second locking surface,
wherein the first and second end-plates of the second adjustment mechanism are respectively fixed to the first and second elements, and wherein the deactivation surface of the control member of the second adjustment mechanism comprises an overtravel adapted to take into account an angular offset of the first and second adjustment mechanisms about the pivot axis.
